(19) United States
(12) Patent Application Publication
(10) Pub. No.: US 2023/0344536 A1
(43) Pub. Date: Oct. 26, 2023

(54) REAL-TIME IMMERSION OF MULTIPLE USERS

(71) Applicant: Funai Electric Co., Ltd., Daito-shi, Osaka-fu (JP)

(72) Inventors: Debmalya BISWAS, Vaud (CH); Seth Adrian MILLER, Longmont, CO (US); Mordehai MARGALIT, Zichron Yaaqov (IL); Nery STRASMAN, Ramat Gan (IL)

(73) Assignee: Funai Electric Co., Ltd., Daito-shi, Osaka-fu (JP)

(21) Appl. No.: 17/908,877

(22) PCT Filed: Dec. 14, 2020
(86) PCT No.: PCT/US2020/064746

§ 371 Date: Sep. 1, 2022

(51) Int. Cl. H04H 60/33; H04H 60/07

(52) U.S. Cl. CPC H04H 60/33; H04H 60/07

(57) ABSTRACT

Technologies are generally described for providing real-time or recorded content along with customized content augmentation stream to enhance a user's experience of the content. A content provider may receive captured feedback from multiple users and select and aggregate a subset of the received feedback based on preferences and emotional state of a user to be presented with the content. The aggregated feedbacks may be customized for the user and delivered as content augmentation stream along with the content to the user.

### BACKGROUND

Unless otherwise indicated herein, the materials described in this section are not prior art to the claims in this application and are not admitted to be prior art by inclusion in this section.

Enjoying a game or a concert in an outdoor venue can be a thrilling experience. While watching a similar event at home is more convenient, time and cost efficient, and can provide additional features such as multiple camera angles with the option to pause in between, it cannot make up for the excitement and social engagement experienced at a stadium or concert hall with thousands of screaming (or swooning) fans who are just as passionate about a team (or singer). There is a special energy and social ambience created by the sense of community that comes with watching an event together with a crowd.

### SUMMARY

The present disclosure generally describes techniques for generation and delivery of content augmentation streams to create an energy and social ambience of attending an event in person.

According to some examples, a system for delivery of augmented content may include a user sub-system with a presentation module configured to present content and a content augmentation stream through two or more channels and a feedback capture module configured to capture user feedback to the presented content. The system may also include a content delivery sub-system comprising one or more computing devices in a content delivery network. The content delivery sub-system may be configured to receive the captured user feedback and provide to a content processing sub-system; and receive the content and the content augmentation stream from the content processing sub-system and deliver to the user sub-system. The system may further include a content processing sub-system to generate or capture the content; generate the content augmentation stream from a plurality of captured user feedbacks, where the content augmentation stream is customized for a particular user to enhance the user's experience of the presented content; and provide the content and the content augmentation stream to the content delivery sub-system for delivery to the user sub-system.

According to other examples, a server part of a system to provide a content augmentation stream may include a communication module configured to facilitate communications with one or more other computing devices; a memory configured to store instructions; and a processor communicatively coupled to the communication module and the memory. The processor, in conjunction with the instructions stored in the memory, may be configured to receive generated or captured content to be presented; receive captured user feedback from a plurality of users; generate a content augmentation stream from the captured user feedback, where the content augmentation stream is customized for a particular user to enhance the user's experience of the content through two or more channels; and provide the content and the content augmentation stream to be presented to the particular user.

According to further examples, a method to provide a content augmentation stream may include receiving generated or captured content to be presented; receiving captured user feedback from a plurality of users; generating a content augmentation stream from the captured user feedback; customizing the content augmentation stream for a particular user to enhance the user's experience of the content through two or more channels; and providing the content and the content augmentation stream to be presented to the particular user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of a system that provides real-time or recorded content along with content augmentation stream;

FIG. 2 includes a conceptual illustration of user equipment to present content with content augmentation stream and to capture user feedback to be used in content augmentation stream generation;

FIG. 3 includes an illustration of example components and actions for a system that provides real-time or recorded content along with content augmentation stream;

FIG. 4 illustrates a computing device, which may be used to manage a content processing system;

FIG. 5 is a flow diagram illustrating an example method for providing real-time or recorded content along with content augmentation stream that may be performed by a computing device such as the computing device in FIG. 4; and

FIG. 6 illustrates a block diagram of an example computer program product, all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to generation and delivery of content augmentation streams to create an energy and social ambience of attending an event in person.

Briefly stated, technologies are generally described for providing real-time or recorded content along with customized content augmentation stream to enhance a user's experience of the content. A content provider may receive captured feedback from multiple users and select and aggregate a subset of the received feedback based on preferences and emotional state of a user to be presented with the content. The aggregated feedbacks may be customized for the user and delivered as content augmentation stream along with the content to the user.

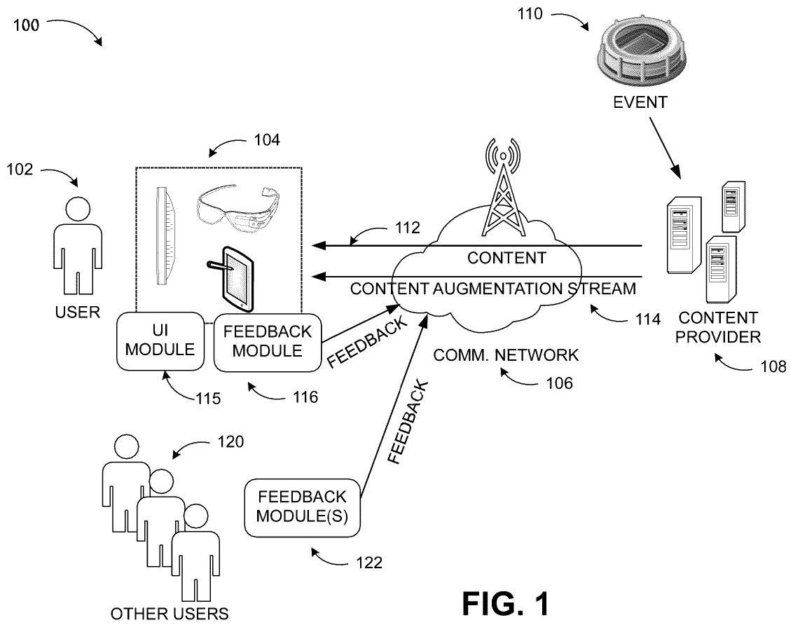

FIG. 1 includes a conceptual illustration of a system that provides real-time or recorded content along with content augmentation stream, arranged in accordance with at least some embodiments described herein.

Diagram 100 shows content (e.g., a live event 110) being captured by a content provider 108. The content provider is represented by multiple servers, general or special purpose computing devices and associated software to receive/generate/store/process/distribute content. The content provider 108 may provide the content 112 and content augmentation stream 114 to user equipment 104, which may include a smart television, a desktop computer, a laptop computer, a tablet device, a portable device, a wearable computer, augmented reality (AR) glasses, virtual reality (VR) glasses, etc. The content 112 and the content augmentation stream 114 are presented by the user equipment 104 to a user 102. The user equipment 104 may also include a feedback module 116, which captures user feedback and provides to the content provider 108 over communication network 106. The content provider 108 may receive feedback captured from other users 120 by respective feedback modules 122 as well.

The content provider 108 may generate the content augmentation stream from the received feedback by selecting a group of users based on one or more of user profiles, user feedbacks, or user locations; aggregating the captured user feedback from the selected group of users; and generating the content augmentation stream using the aggregated user feedback from the selected group of users. The group of users may be selected based on an alignment of the feedback from other users 120 with the feedback of the user 102, an alignment of user profiles, and/or locations of the various users. The content augmentation stream may be customized to enhance an emotional state of the particular user and to create the energy and social ambience of a crowd in the event for the user to experience in their home environment. The content augmentation stream may be generated based on users' feedback while watching pre-recorded or live (real time) content and presented to a user along with the content being presented pre-recorded or live.

In some examples, the content 112 (and the content augmentation stream 114) may be delivered to the user equipment 104 by a content delivery system separate from the content provider 108. In further examples, the content augmentation stream 114 may be generated by the content delivery system. For example, the content delivery system may be the owner/manager of the communication network 106. The communication network 106 may include wired and/or wireless sub-networks such as local area networks (LANs), digital subscriber line (DSL) networks, optical networks, cable networks, wireless LANs, cellular networks, terrestrial or satellite communication links, and comparable ones, which can provide sufficient bandwidth for streaming content and content augmentation.

Fifth generation (5G) technology standard for cellular networks called 5G network is the most recent network. 5G networks are digital cellular networks, in which the service area is divided into small geographical areas called cells. All 5G wireless devices in a cell exchange digital data with the Internet and the telephone network by radio waves through a local antenna in the cell. 5G networks provide greater bandwidth compared to previous standards allowing higher download speeds more than 10 gigabits per second (Gbit/s). This, in turn, allows cellular service providers to become Internet service providers interconnecting most user devices.

5G protocol replaces a number of the hardware components of the cellular network with software that “virtualizes” the network by using the common language of Internet Protocol (IP). The increased speed/bandwidth is achieved in 5G networks partly by using higher-frequency radio waves than current cellular networks. Low band 5G uses a similar frequency range to current 4G network in the 600-700 MHz range supporting download speeds a little higher than 4G (30-250 megabits per second). Mid band 5G uses microwaves in the range of 2.5-3.7 GHz allowing speeds of 100-900 Mbit/s with each cell tower providing service up to several miles in radius. High band 5G uses frequencies in the range of 25-39 GHz, near the millimeter wave band, although higher frequencies may be used in the future. The high band may achieve download speeds of a gigabit per second comparable to cable Internet. Thus, 5G networks may enable transmission of content and content augmentation streams to user equipment and may provide sufficient bandwidth for content and content augmentation streams.

In other examples, user feedback preferences may be based on a user profile (e.g., preference to share/receive a particular type of content), feedback type (audio/video/haptic or mix), or emotion type (filter/deliver feedback by same/different emotion type). The central feedback processing module may filter the aggregated stream based on the feedback delivery preferences specified by the user using a filtering algorithm to retain the user preferences with regard to the user profiles, feedback, and emotion types. The central feedback processing module may employ a profiling/ranking algorithm to output top streams to be distributed to the user.

Thus, an example system may include multiple devices (user equipment 104) for transmitting and delivering content such as audio, visual, haptic, bio-matric and/or other data. Each device may be associated with sensors (embedded and/or in vicinity), which may be in communication with a central feedback processing module at the content provider 108. A user may register with the central feedback processing module and configure their feedback delivery preferences and privacy settings using a user interface module 115 at the user equipment 104. The user equipment 104 may capture the user feedback/reactions, perform privacy preserving actions (using a privacy module) on the captured stream and transmit the captured stream to the central feedback module via the communication network 106. The central feedback processing module may augment, rank the received user feedback, and create a personalized crowd feedback stream for the registered users. The personalized crowd feedback stream may include audio, visual, and/or haptic feedback customized to enhance a user's content while the content is being presented to the user. The central feedback processing module may then transmit the personalized crowd feedback stream as content augmentation stream 114 to the respective user equipment (synchronously with the delivered content 112), which presents the stream and the content to the user 102.

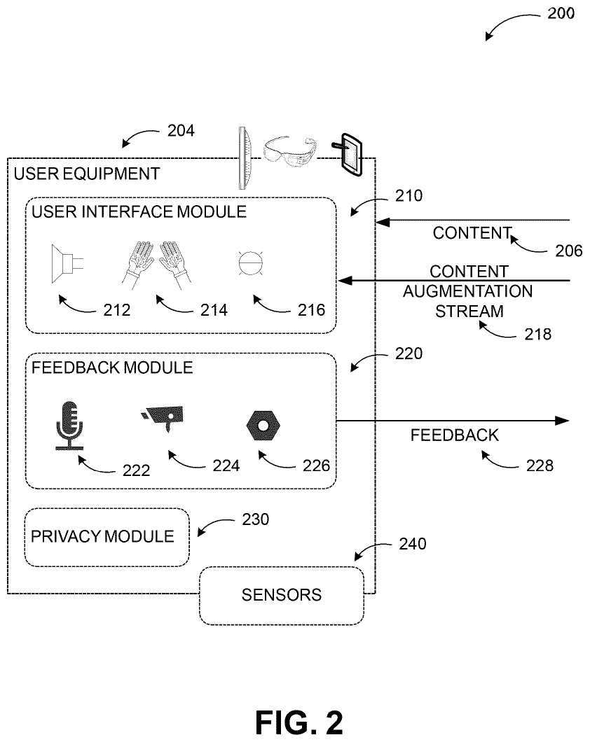

FIG. 2 includes a conceptual illustration of user equipment to present content with content augmentation stream and to capture user feedback to be used in content augmentation stream generation, arranged in accordance with at least some embodiments described herein.

Diagram 200 shows user equipment 204 including user interface module 210, feedback module 220, privacy module 230, and sensors 240. The user interface module 210 may include, among other input/output devices (e.g., keyboard, mouse, pen, eye-tracking, etc.), audio output device(s) 212, haptic device(s) 214, and lighting device(s) 216 (e.g., background lighting, room lighting, etc.). Feedback module 220 may be associated with audio input device(s) 222 (e.g., a microphone), visual input device(s) 224 (e.g., a camera), and other sensors 226 (e.g., body sensors such as temperature, blood pressure detection sensors, etc.). Content 206 may be provided to the user equipment 204 by the content provider (not shown). Content augmentation stream 218 may be provided to the user interface module 210, and the user feedback 228 may be provided by the feedback module 220 to a central feedback processing module of the content provider.

User equipment 204 may communicate with sensors 240 (embedded and/or in vicinity, connected via wired or wireless communications such as Bluetooth®, NFC, etc.) to deliver content and capture feedback including audio, visual, and/or haptic aspects. User equipment 204 may transmit captured user feedback 228 via a communications network to a central feedback processing module to be aggregated and ranked for redistribution as personalized content augmentation feedback to the respective user equipment. The central feedback processing module may be part of the content provider, content delivery system, or an independent third-party platform.

A user may interact with user equipment 204 via the embedded user interface module 210. In addition to facilitating the presentation of content (and content augmentation stream), the user interface module 210 may allow the user to configure feedback delivery preferences, i.e., the type of event reactions that they may be interested in sharing and receiving. User interface module configuration may also include user privacy settings which are processed by the privacy module 230 of the user equipment 204. In other examples, the privacy processing may also be performed in a centralized fashion by the central feedback processing module.

In some examples, the content augmentation stream (and/or the content) may be provided as a single signal, which is processed by one or more modules in the user equipment and respective components (video, audio, haptic, etc.) distributed to respective output devices. In other examples, different components of the signal (audio, video, haptic, etc.) may be provided through separate channels to the user equipment. Furthermore, embodiments are not limited to 5G networks. Other wireless technologies such as 4G, LTE, and any current or future cellular wireless technologies or satellite communication technologies may be used in implementing transmission of content with content augmentation stream. For example, microwave, satellite, local area network (LAN), whole-city Wifi®, and combinations of similar technologies may be employed.

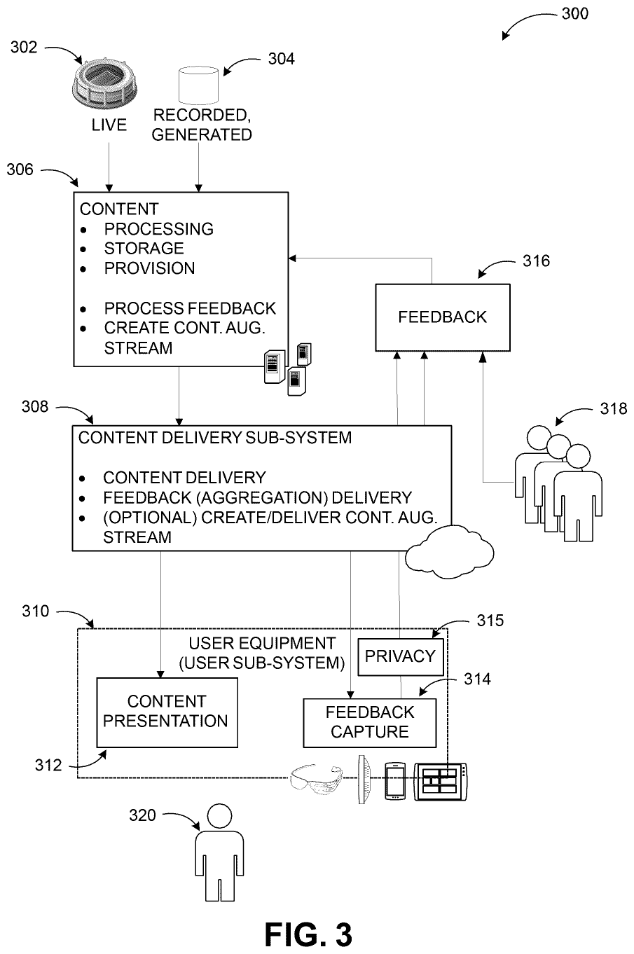

FIG. 3 includes an illustration of example components and actions for a system that provides real-time or recorded content along with content augmentation stream, arranged in accordance with at least some embodiments described herein.

Diagram 300 shows live event 302 or recorded/generated content 304 received by content provider 306 to be processed, stored, and provided for delivery. The content provider 306 may also process feedback 316 from users 318 and create a content augmentation stream. content delivery sub-system 308 may delivery the content and the content augmentation stream to user equipment (user sub-system) 310 for content presentation 312 to user 320. User equipment (user sub-system) 310 may also capture feedback (314) from the user 320 and provide to the content provider 306. Content delivery sub-system 308 may receive the captured user feedback and provide to a content processing sub-system. The content delivery sub-system 308 may then receive the content and the content augmentation stream from the content processing sub-system and deliver to the user equipment (user sub-system) 310. Content delivery sub-system 308 may optionally perform feedback aggregation/delivery and/or generation of content augmentation stream in some examples. In other examples, a privacy module 315 at the user equipment (user sub-system) 310 may perform privacy preservation actions as described herein.

In an illustrative interaction between the components of the example system, a user may register with the central feedback processing module and configure their content augmentation preferences and privacy settings using the user interface module and/or the feedback module of the user equipment. Example settings may be based on user profile, content augmentation type, and emotion type. For example, the user may specify that he/she is only interested in receiving feedback from other users having a shared interest (e.g., they like the same band/singer, or support the same team) or location (reside in a specific geographic region, locality, city, country) or speak the same language, etc. The user may also indicate her/his preferences with respect to the feedback channel, e.g., that they are interested in receiving audio feedback only, video feedback only, haptic feedback only, or a combination thereof. Extended settings may also allow the user to filter feedback by emotion type, where the user is only delivered feedback of users experiencing similar emotion. For example, when a goal is scored by Team A in a soccer game between Teams A and B, Team A's supporters will be jubilant, while Team B's supporters will be disheartened; and the user might be interested in receiving feedback corresponding to one emotion type, or both. In addition to live events, pre-recorded events and/or generated content may also be used. Generated content may include virtual reality content, animated content, and similar ones.

An example scenario for pre-recorded content may include a game recording being (re-)broadcast, and the augmented content stream being generated based on the ‘live’ feedback of users watching the re-broadcast. Another example scenario may include a “live” game broadcast being recorded and stored along with the (captured) feedback of users watching it live (in real time). Later, when a user starts watching the pre-recorded game from their personal (on-demand) recordings library, for example, the augmented content stream may still be generated based on the recorded feedback of users who had watched the game live.

Similar to the content augmentation delivery settings, privacy settings may define user input capture restrictions and allow the user to specify whether they are not comfortable with sharing their personal information, face, audio, location, certain types of movements/emotions, etc. User equipment may capture user event feedback/reactions (using its embedded and connected sensors) in real-time during live broadcast of an event, for example. The privacy module of the user equipment may perform privacy preserving actions on captured user feedback such as anonymizing personal information, blurring the user's face, removing the audio feed, filtering out certain types of movements, audio/facial expressions, etc. in accordance with the user's privacy settings. In some examples, part of or all of the privacy preservation actions may be performed at the central feedback processing module.

User equipment may transmit the privacy compliant stream incorporating privacy protection measures (e.g., anonymization) to the central feedback processing module over the communications network along with event related tags such as event name, type, channel, etc. The central feedback processing module may aggregate incoming user feedback streams by event and may create a personalized crowd feedback stream for every registered user watching that event. One example process may be as follows: The central feedback processing module filters the aggregated stream based on the feedback delivery preferences specified by the user, for example, retaining only those streams satisfying the user preferences with respect to user profiles, feedback and emotion types; and the central feedback processing module uses a profiling/ranking algorithm to output the top N streams to be distributed to a user. The selected streams, and even the number of streams (“N”) used in the composition of personalized content augmentation delivery may be updated/adapted during the broadcast to improve user engagement. The filtering and selection (profiling/ranking) may be performed by artificial intelligence (AI) or machine learning (ML) algorithms.

AI algorithms control any device that perceives its environment and takes actions that maximize its chance of successfully achieving predefined goals such as selecting best fitting feedbacks from other users for a particular user. A subset of AI, machine learning (ML) algorithms build a mathematical model based on sample data (training data) in order to make predictions or decisions without being explicitly programmed to do so. In some examples, an AI planning algorithm or a specific ML algorithm may be employed to filter, select, and rank user feedbacks for aggregation and delivery to a particular user. Such an algorithm may receive user data (profile, location, preferences, emotions, etc.) and predict which user feedbacks would be suitable for the user whose data is received. The ML algorithm may facilitate both supervised and unsupervised learning.

In a practical implementation example, a Reinforcement Learning (RL) based feedback recommender may be designed as follows. An RL Recommender includes primarily a reward function and RL agent policy, where the reward function is responsible for computing rewards to be assigned to recommended actions, and the policy is responsible for selecting the next best action(s) to be recommended based on their associated rewards. The algorithm may start with a randomized list of streams satisfying the user feedback delivery preferences, for example, a random subset of streams obtained as output during initial selection. The algorithm may continuously monitor user engagement/satisfaction as the personalized stream is delivered to the user. The engagement may be measured based on explicit input provided by a user, e.g., “Change this stream, I do (did) not like this person or his reactions!”, during or after the broadcast. It may also include implicit user engagement level inferred from reading facial expressions or wearables capturing the user excitement level, where the user seems unhappy even when his team is winning, for example, or the user's emotions being inconsistent with the emotions of other users watching the same event. The user engagement score may be used by the RL reward function to assign rewards to the distributed streams. The continuously evolving rewards associated with existing and new feedback streams may be used by the RL agent policy to select the streams to be distributed to a user at any particular time during the broadcast.

The central feedback processing module may transmit the personalized stream to the user equipment of the registered user over communication network, which present it to the user with the help of its embedded and connected sensors and control devices. For example, the presentation may include changing the ambient light color or surround sound along with displaying the personalized stream on a smart television.

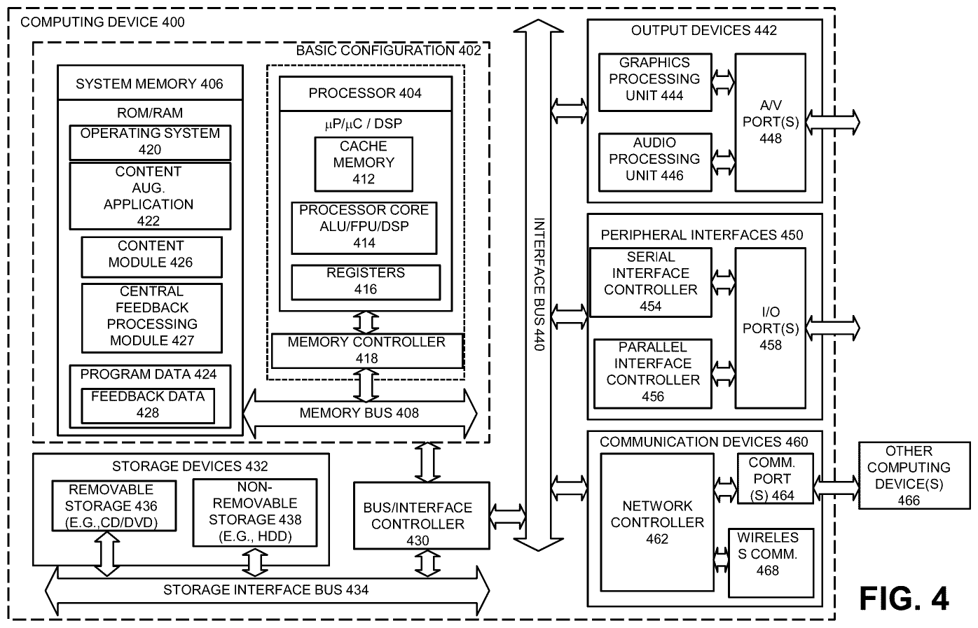

FIG. 4 illustrates a computing device, which may be used to manage a content processing system, arranged in accordance with at least some embodiments described herein.

In an example basic configuration 402, the computing device 400 may include one or more processors 404 and a system memory 406. A memory bus 408 may be used to communicate between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one or more levels of caching, such as a cache memory 412, a processor core 414, and registers 416. The example processor core 414 may include an arithmetic logic unit (ALU), a floating point unit (FPU), a digital signal processing core (DSP core), or any combination thereof. An example memory controller 418 may also be used with the processor 404, or in some implementations, the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, a content augmentation application 422, and program data 424. The content augmentation application 422 may include a content module 426 and a central feedback processing module 427. The content augmentation application 422 may be configured to receive/process/provide live or pre-recorded content through the content module 426, receive/process user feedback from multiple user equipment while users are watching live or pre-recorded content, generate content augmentation streams for individual users through the central feedback processing module 427, and provide selected content augmentation streams along with corresponding content to respective users. The program data 424 may include feedback data 428, among other data, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information, and which may be accessed by the computing device 400. Any such computer storage media may be part of the computing device 400.

The computing device 400 may also include an interface bus 440 for facilitating communication from various interface devices (e.g., one or more output devices 442, one or more peripheral interfaces 450, and one or more communication devices 460) to the basic configuration 402 via the bus/interface controller 430. Some of the example output devices 442 include a graphics processing unit 444 and an audio processing unit 446, which may be configured to communicate to various external devices such as a display or speakers via one or more A/V ports 448. One or more example peripheral interfaces 450 may include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 460 includes a network controller 462, which may be arranged to facilitate communications with one or more other computing devices 466 over a network communication link via one or more communication ports 464. The one or more other computing devices 466 may include servers at a datacenter, customer equipment, and comparable devices. The network controller 462 may also control operations of a wireless communication module 468, which may facilitate communication with other devices via a variety of protocols using a number of frequency bands such as WiFi®, cellular (e.g., 4G, 5G), satellite link, terrestrial link, etc.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 400 may be implemented as a part of a specialized server, mainframe, or similar computer that includes any of the above functions. The computing device 400 may also be implemented as a personal computer including both laptop computer and non-laptop computer configurations. Furthermore, computing device 400 may be implemented as a standalone, single device, as a distributed computing system, multiple computers co-working with each other, etc.

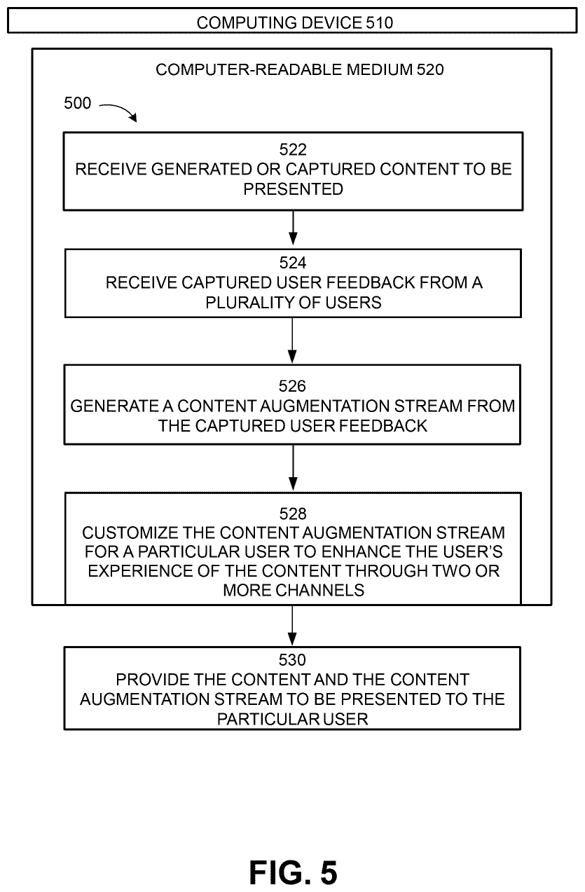

FIG. 5 is a flow diagram illustrating an example method for providing real-time or recorded content along with content augmentation stream that may be performed by a computing device such as the computing device in FIG. 4, arranged in accordance with at least some embodiments described herein.

Example methods may include one or more operations, functions, or actions as illustrated by one or more of blocks 522, 524, 526, 528, and 530 may in some embodiments be performed by a computing device such as the computing device 400 in FIG. 4. Such operations, functions, or actions in FIG. 5 and in the other figures, in some embodiments, may be combined, eliminated, modified, and/or supplemented with other operations, functions or actions, and need not necessarily be performed in the exact sequence as shown. The operations described in the blocks 522-530 may be implemented through execution of computer-executable instructions stored in a computer-readable medium such as a computer-readable medium 520 of a computing device 510.

An example process to provide real-time or recorded content along with content augmentation stream may begin with block 522, “RECEIVE GENERATED OR CAPTURED CONTENT TO BE PRESENTED”, where captured live content, pre-recorded live content, or generated content may be received by a content provider, for example, at content augmentation application 422 of a server such as computing device 400.

Block 522 may be followed by block 524, “RECEIVE CAPTURED USER FEEDBACK FROM A PLURALITY OF USERS”, where central feedback processing module 427 of the content augmentation application 422 may receive feedback from a number of users. The feedback may include captured audio, video, haptic input, inferred emotions, and similar while the users are watching the content in live mode or pre-recorded mode. In some examples, the received feedback may be partially or completely anonymized for privacy protection purposes.

Block 524 may be followed by block 526, “GENERATE A CONTENT AUGMENTATION STREAM FROM THE CAPTURED USER FEEDBACK”, where the central feedback processing module 427 may generate content augmentation stream(s) by, for example, selecting a group of users based on one or more of user profiles, user feedbacks, or user locations; aggregating the captured user feedback from the selected group of users; and generating the content augmentation stream using the aggregated user feedback from the selected group of users.

Block 526 may be followed by block 528, “CUSTOMIZE THE CONTENT AUGMENTATION STREAM FOR A PARTICULAR USER TO ENHANCE THE USER'S EXPERIENCE OF THE CONTENT THROUGH TWO OR MORE CHANNELS”, where the central feedback processing module 427 may customize the content augmentation stream based on a receiving user's emotional state, preference, etc.

Block 528 may be followed by block 530, “PROVIDE THE CONTENT AND THE CONTENT AUGMENTATION STREAM TO BE PRESENTED TO THE PARTICULAR USER”, where the content augmentation application 422 may provide the received content along with the content augmentation stream to the receiving user. Two or more channels may be used to deliver the content and the content augmentation stream.

The operations included in process 500 are for illustration purposes. Providing real-time or recorded content along with content augmentation stream may be implemented by similar processes with fewer or additional operations, as well as in different order of operations using the principles described herein. The operations described herein may be executed by one or more processors operated on one or more computing devices, one or more processor cores, and/or specialized processing devices, among other examples.

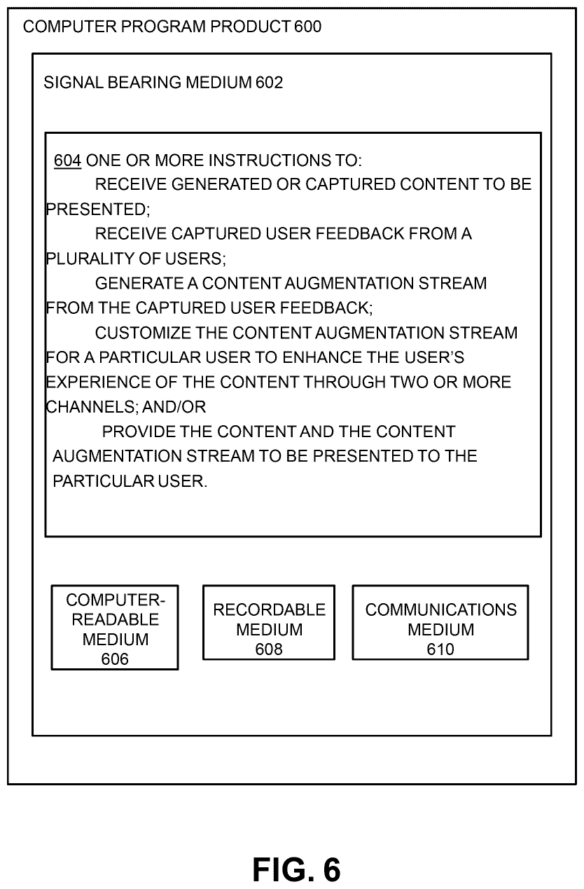

FIG. 6 illustrates a block diagram of an example computer program product, arranged in accordance with at least some embodiments described herein.

In some examples, as shown in FIG. 6, a computer program product 600 may include a signal bearing medium 602 that may also include one or more machine readable instructions 604 that, in response to execution by, for example, a processor may provide the functionality described herein. Thus, for example, referring to the processor 404 in FIG. 4, the content augmentation application 422 may perform or control performance of one or more of the tasks shown in FIG. 6 in response to the instructions 604 conveyed to the processor 404 by the signal bearing medium 602 to perform actions associated with providing real-time or recorded content along with content augmentation stream as described herein. Some of those instructions may include, for example, receiving generated or captured content to be presented; receiving captured user feedback from a plurality of users; generating a content augmentation stream from the captured user feedback; customizing the content augmentation stream for a particular user to enhance the user's experience of the content through two or more channels; and/or providing the content and the content augmentation stream to be presented to the particular user, according to some embodiments described herein.

In some implementations, the signal bearing medium 602 depicted in FIG. 6 may encompass computer-readable medium 606, such as, but not limited to, a hard disk drive (HDD), a solid state drive (SSD), a compact disc (CD), a digital versatile disk (DVD), a digital tape, memory, and comparable non-transitory computer-readable storage media. In some implementations, the signal bearing medium 602 may encompass recordable medium 608, such as, but not limited to, memory, read/write (R/W) CDs, R/W DVDs, etc. In some implementations, the signal bearing medium 602 may encompass communications medium 610, such as, but not limited to, a digital and/or an analog communication medium (e.g., a fiber optic cable, a waveguide, a wired communication link, a wireless communication link, etc.). Thus, for example, the computer program product 600 may be conveyed to one or more modules of the processor 604 by a radio frequency (RF) signal bearing medium, where the signal bearing medium 602 is conveyed by the communications medium 610 (e.g., a wireless communications medium conforming with the IEEE 802.11 standard).

According to some examples, a system for delivery of augmented content may include a user sub-system with a presentation module configured to present content and a content augmentation stream through two or more channels and a feedback capture module configured to capture user feedback to the presented content. The system may also include a content delivery sub-system comprising one or more computing devices in a content delivery network. The content delivery sub-system may be configured to receive the captured user feedback and provide to a content processing sub-system; and receive the content and the content augmentation stream from the content processing sub-system and deliver to the user sub-system. The system may further include a content processing sub-system to generate or capture the content; generate the content augmentation stream from a plurality of captured user feedbacks, where the content augmentation stream is customized for a particular user to enhance the user's experience of the presented content; and provide the content and the content augmentation stream to the content delivery sub-system for delivery to the user sub-system.

According to other examples, the two or more channels may include one or more of an audio channel, a visual channel, or a haptic channel. The content processing sub-system may be configured to generate the content augmentation stream from the plurality of captured user feedbacks through selection of a group of users based on one or more of user profiles, user feedbacks, or user locations; aggregation of captured user feedback from the selected group of users; and generation of the content augmentation stream using the aggregated user feedback from the selected group of users. The content processing sub-system may be configured to select the group of users based on an alignment of their user feedbacks with the user feedback of the particular user. The content processing sub-system may be configured to customize the content augmentation stream to enhance an emotional state of the particular user. The content processing sub-system may be configured to customize the content augmentation stream based on a preference of the particular user.

According to further examples, one or both of the feedback capture module or the content processing sub-system may be further configured to anonymize one or more portions of the captured user feedback to preserve user privacy. The content processing sub-system may be configured to generate or capture the content through capture of a live event, retrieval of a pre-recorded event, or creation of the content. The feedback capture module may be configured to capture the user feedback through one or more sensors communicatively coupled to the user sub-system. The one or more sensors may include a microphone, a pressure sensor, a camera, a light sensor, or a body sensor. The user sub-system may include one or more of a display device, a speaker, a lighting source, or a tactile device. The user sub-system may be part of a wall-mount display device, a desktop computer, a handheld computer, a wearable computer, a vehicle-mount computer, or augmented reality (AR) glasses.

According to other examples, a server part of a system to provide a content augmentation stream may include a communication module configured to facilitate communications with one or more other computing devices; a memory configured to store instructions; and a processor communicatively coupled to the communication module and the memory. The processor, in conjunction with the instructions stored in the memory, may be configured to receive generated or captured content to be presented; receive captured user feedback from a plurality of users; generate a content augmentation stream from the captured user feedback, where the content augmentation stream is customized for a particular user to enhance the user's experience of the content through two or more channels; and provide the content and the content augmentation stream to be presented to the particular user.

According to further examples, the two or more channels may include one or more of an audio channel, a visual channel, or a haptic channel. The processor may be configured to generate the content augmentation stream from the captured user feedback through selection of a group of users based on one or more of user profiles, user feedbacks, or user locations; aggregation of the captured user feedback from the selected group of users; and generation of the content augmentation stream using the aggregated user feedback from the selected group of users. The processor may be configured to select the group of users based on an alignment of their user feedback with a user feedback of the particular user. The processor may be configured to customize the content augmentation stream to enhance an emotional state of the particular user.

According to some examples, the processor may be configured to customize the content augmentation stream based on a preference of the particular user. The processor is further configured to anonymize one or more portions of the captured user feedback to preserve user privacy. The content may be a captured live event, a retrieved pre-recorded event, or a created content. The user feedback may be captured through one or more sensors and communicated to the server, the one or more sensors comprising a microphone, a pressure sensor, a camera, a light sensor, or a body sensor. The provided content and the content augmentation stream may be presented to the particular user through one or more of: a display device, a speaker, a lighting source, or a tactile device.

According to further examples, a method to provide a content augmentation stream may include receiving generated or captured content to be presented; receiving captured user feedback from a plurality of users; generating a content augmentation stream from the captured user feedback; customizing the content augmentation stream for a particular user to enhance the user's experience of the content through two or more channels; and providing the content and the content augmentation stream to be presented to the particular user.

According to other examples, the two or more channels may include one or more of an audio channel, a visual channel, or a haptic channel. Generating the content augmentation stream from the captured user feedback may include selecting a group of users based on one or more of user profiles, user feedbacks, or user locations; aggregating the captured user feedback from the selected group of users; and generating the content augmentation stream using the aggregated user feedback from the selected group of users. Selecting the group of users may include selecting the group of users further based on an alignment of their user feedback with a user feedback of the particular user. The method may further include customizing the content augmentation stream to enhance an emotional state of the particular user. The method may also include customizing the content augmentation stream based on a preference of the particular user. The method may further include anonymizing one or more portions of the captured user feedback to preserve user privacy. Receiving the generated or captured content to be presented may include receiving one or more of a captured live event, a retrieved pre-recorded event, or a created content.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, t some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1-30. (canceled)

31. A system for delivery of augmented content comprising:
a user sub-system comprising:
a presentation module configured to present content and a content augmentation stream through two or more channels;
a feedback capture module configured to capture user feedback to the presented content; and
a content delivery sub-system comprising one or more computing devices in a content delivery network, the content delivery sub-system configured to:
receive the captured user feedback and provide to a content processing sub-system; and
receive the presented content and the content augmentation stream from the content processing sub-system and deliver to the user sub-system, wherein the content processing sub-system configured to:
generate or capture the presented content;
generate the content augmentation stream from a plurality of captured user feedbacks, wherein the content augmentation stream is customized for a particular user by selecting the plurality of captured user feedbacks aligned to the particular; and
provide the presented content and the content augmentation stream to the content delivery sub-system for delivery to the user sub-system.

32. The system of claim 31, wherein the two or more channels include one or more of an audio channel, a visual channel, or a haptic channel.

33. The system of claim 31, wherein the content processing sub-system is configured to generate the content augmentation stream from the plurality of captured user feedbacks through:
selection of a group of users based on one or more of user profiles, user feedbacks, or user locations;
aggregation of captured user feedback from the selected group of users; and
generation of the content augmentation stream using the aggregated user feedback from the selected group of users.

34. The system of claim 33, wherein the content processing sub-system is configured to select the group of users based on an alignment of their user feedbacks with the user feedback of the particular user.

35. The system of claim 31, wherein the content processing sub-system is configured to customize the content augmentation stream to enhance an emotional state of the particular user.

36. The system of claim 31, wherein the content processing sub-system is configured to customize the content augmentation stream based on a preference of the particular user.

37. The system of claim 31, wherein one or both of the feedback capture module or the content processing sub-system are further configured to:
anonymize one or more portions of the captured user feedback to preserve user privacy.

38. The system of claim 31, wherein the content processing sub-system is configured to generate or capture the presented content through capture of a live event, retrieval of a pre-recorded event, or creation of the content.

39. The system of claim 31, wherein the feedback capture module is configured to capture the user feedback through one or more sensors communicatively coupled to the user sub-system.

40. The system of claim 39, wherein the one or more sensors comprise: a microphone, a pressure sensor, a camera, a light sensor, or a body sensor.

41. The system of claim 31, wherein the user sub-system comprises one or more of: a display device, a speaker, a lighting source, or a tactile device.

42. The system of claim 31, wherein the user sub-system is part of: a wall-mount display device, a desktop computer, a handheld computer, a wearable computer, a vehicle-mount computer, or augmented reality (AR) glasses.

43. A method to provide a content augmentation stream, the method comprising:
receiving generated or captured content to be presented;
receiving captured user feedback from a plurality of users;
generating a content augmentation stream from the captured user feedback;
customizing the content augmentation stream for a particular user by selecting a plurality of captured user feedbacks aligned to the feedback of the particular user; and
providing the content and the content augmentation stream to be presented to the particular user.

44. The method of claim 43, wherein the two or more channels include one or more of an audio channel, a visual channel, or a haptic channel.

45. The method of claim 43, wherein generating the content augmentation stream from the captured user feedback comprises:
selecting a group of users based on one or more of user profiles, user feedbacks, or user locations;
aggregating the captured user feedback from the selected group of users; and
generating the content augmentation stream using the aggregated user feedback from the selected group of users.

46. The method of claim 45, wherein selecting the group of users comprises selecting the group of users further based on an alignment of their user feedback with a user feedback of the particular user.

47. The method of claim 43, further comprising:
customizing the content augmentation stream to enhance an emotional state of the particular user.

48. The method of claim 43, further comprising:
customizing the content augmentation stream based on a preference of the particular user.

49. The method of claim 43, further comprising:
anonymizing one or more portions of the captured user feedback to preserve user privacy.

50. The method of claim 43, wherein receiving the generated or captured content to be presented comprises receiving one or more of a captured live event, a retrieved pre-recorded event, or a created content.
